(19) United States
(12) Patent Application Publication
(10) Pub. No.: US 2026/0018928 A1
(43) Pub. Date: Jan. 15, 2026

(54) SMART TOOL HOLDER WIRELESS CHARGING MECHANISM AND THE WIRELESS CHARGING METHOD

(71) Applicant: National Chung Cheng University, Minhsiung (TW)

(72) Inventors: Her-Terng YAU, Minhsiung (TW); Dian-Ying CAI, Minhsiung (TW); Song- Wei HONG, Minhsiung (TW); Heng- Chi CHANG, Minhsiung (TW)

(21) Appl. No.: 18/769,921

(22) Filed: Jul. 11, 2024

(51) Int. Cl. H02J 50/10; B23Q 3/155; H02J 7/00; H02J 50/40; H02J 50/90

(52) U.S. Cl. CPC H02J 50/10; B23Q 3/15526; H02J 7/0044; H02J 50/40; H02J 50/90

(57) ABSTRACT

A wireless charging technique for a smart tool holder, each tool base incorporating a corresponding smart tool holder having a power module providing power to an electronic module within the smart tool holder, the power module comprising a rechargeable battery, and the rechargeable battery being electrically connected to a wireless charging receiver. Each charging pad corresponds to a tool base, and the charging pad contains a wireless charging transmitter. Upon incorporation of the smart tool handle into the tool magazine, the wireless charging transmitter of the charging pad wirelessly charges the rechargeable battery in response to the wireless charging receiver in the smart tool handle on the tool base. It is not necessary to remove the smart tool holder and place it in a fixed charging cradle for charging, so that the smart tool holder can be charged while it is in the tool magazine of the machining machine.

### TECHNICAL FIELD

The present invention relates to the technical field of smart tool holders for tool machines, and in particular relates to a wireless charging mechanism for smart tool holders, which enables the smart tool holders to be charged while in the machining tool magazine.

### BACKGROUND ART

In the production process, tools play an extremely important role, the large number of tools and the complexity of the application, making the use and management of tools become an important factor in reducing production costs and shortening production time. The role of the tool magazine of CNC machine tools is not only to store the tools needed in the machining process, but also responsible for moving the tools to be used in the next process to the tool change position. Traditional tool management uses 1D and 2D barcodes, which are inexpensive, but the barcodes are limited in the amount of information they can record, and the barcodes themselves are often subject to wear and tear due to environmental factors; traditional tool management uses RFID, which has the advantage of repeated use and good environmental tolerance. However, RFID is not an active communication mechanism, and in order to transmit stable data within a short period of time, the transmission distance cannot be increased, resulting in limitations in tool management.

The development trend of modern factories, all towards automation and intelligent production mode of production, so the real-time monitoring of the processing status and access to real-time information on the tool can enhance the productivity of machinery and equipment, as well as the competitiveness of the product. Therefore, there is the generation of intelligent tool holder, the sensing mechanism of several measurement devices in the tool holder body inside the connection part, through the active rotation angle sensing method, to improve the sensing characteristics to reduce the coupling effect, and can detect the machining process of the whole domain of the force situation.

However, due to the miniaturization of the system and the need to embed wireless transmission components and sensors into the device, the size of the batteries is also limited, making it impossible to meet the demand for power for the smart tools, and with the large number of tools in the factory, it would be labor-intensive and time-consuming to replace the batteries in each tool or to take out the tools one by one and recharge them.

### CONTENT OF THE INVENTION

It is an object of the present invention to provide a wireless charging mechanism for a smart tool holder, which manages the charging of the smart tool holder after the tool magazine has received the tool.

In order to achieve the above object, the present invention provides a wireless charging mechanism for smart tool holders, which is applied to a tool magazine of a tool machine, the tool magazine comprises a plurality of tool bases, each of which is used to store a corresponding smart tool holder, the smart tool holder is provided with a power module to provide power to an electronic module inside the smart tool holder, the power module comprises a rechargeable battery, and the rechargeable battery is electrically connected to a wireless charging receiver. The tool magazine also comprises a plurality of charging pads, each of which is disposed in relation to a tool base, and the charging pads are provided with a wireless charging transmitter, and the wireless charging transmitter of the charging pads wirelessly charges the rechargeable batteries in the smart tool holder after the smart tool holder is incorporated into the tool magazine in relation to the wireless charging receiver in the smart tool holder.

Further, the wireless charging transmitter and the wireless charging receiver have a wireless charging distance greater than the holding distance.

Further, the smart tool holder further comprises a charge detection module electrically coupled to the wireless charging receiver for detecting that the smart tool holder has been positioned relative to the charging pad and controlling the wireless charging transmitter to wirelessly charge the rechargeable battery.

Further, the wireless charging transmitter and the wireless charging receiver are electromagnetically inductively coupled for power transmission. Or the wireless charging transmitter and the wireless charging receiver are magnetically field resonantly coupled for power transmission. Or the power transmission is by electric field coupling between the wireless charging transmitter and the wireless charging receiver.

Further, the charging pad and the wireless charging transmitter are in a planar shape facing the wireless charging receiver of the smart tool holder. Or the charging pad and the wireless charging transmitter are in a curved shape, with the curved concave surface facing the wireless charging receiver of the smart tool holder.

This case is characterized by a wireless charging receiver and a rechargeable lithium-ion battery inside the smart tool handle, with a wireless charging transmitter inside each charging pad corresponding to a tool base, and when the tool magazine receives the tool, the wireless charging transmitter of the charging board corresponds to the wireless charging receiver in the smart tool holder, and charges the rechargeable battery through the electromagnetic field generated by the energization of the wireless charging transmitter and the electromagnetic induction with the wireless charging receiver. There is no need to remove the smart tool holder and place it in a fixed charging base to charge it, so that it can be charged while it is in the machine's tool magazine.

### BRIEF DESCRIPTION OF THE DRAWINGS

FIG. 1 shows a three-dimensional schematic diagram of the wireless charging mechanism of the present embodiment.

FIG. 2 is a side view of the magazine with the tool in the backward position of present embodiment.

FIG. 3 is a side view of the magazine after closing the tool of present embodiment.

FIG. 4 is a three-dimensional schematic diagram of the wireless charging mechanism of another embodiment of the present embodiment.

FIG. 5 is a flowchart of the wireless charging method of the present embodiment.

### DETAILED DESCRIPTION OF THE EMBODIMENTS

The following is a detailed description of the various embodiments of the present invention, together with the drawings for illustrative purposes. In addition to these detailed descriptions, the present invention may also be broadly implemented in other embodiments, and any easy substitution, modification, or equivalent change of any of the described embodiments is included in the scope of the present invention, subject to the scope of the patent application. In the description of the specification, many specific details are provided in order to provide the reader with a more complete understanding of the invention; however, the invention may still be operable with some or all of the specific details omitted. In addition, well-known steps or components are not described in detail to avoid unnecessarily limiting the invention. Components that are the same or similar in the schematic will be represented by the same or similar symbols. It is important to note that the diagrams are for illustrative purposes only, and do not represent the actual size or number of components. Some details may not be shown in full in order to keep the diagrams concise.

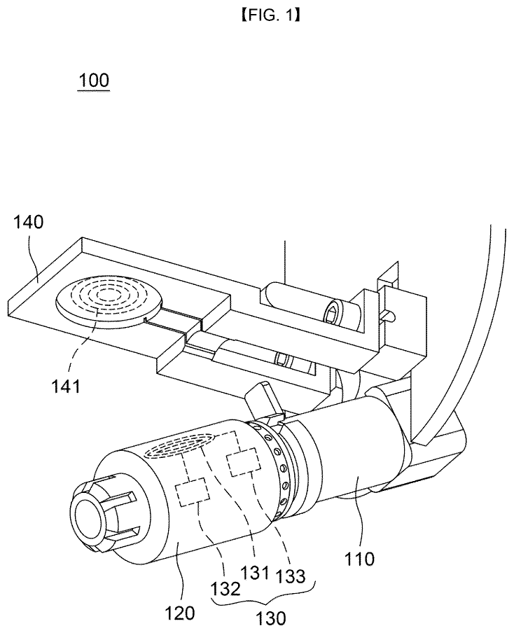

Please refer to FIG. 1 for a three-dimensional schematic diagram of the wireless charging mechanism of the present embodiment. The present embodiment is a wireless charging mechanism for a smart tool holder, applied to a tool magazine 100 of a tool machine, which may be a machine tool manufacturing equipment such as a milling machine, a drilling machine, a lathe, or a sawing machine, and which is fitted with or connected to the tool magazine 100 and to a tool changer arm (not shown in the figure). The tool magazine 100 comprises a plurality of tool base 110, each of which holds a corresponding smart tool holder 120, each of which may be fitted with a tool (not shown), such as a milling cutter, a drill, a lathe cutter, a saw blade, or other tool corresponding to the tool machine.

The smart tool holder 120 is provided with a power module 130 to provide power to an electronic module within the smart tool holder 120, the power module 130 comprises a rechargeable battery 132, and the rechargeable battery 132 is electrically connected to a wireless charging receiver 131. The tool magazine 100 also comprises a plurality of charging pads 140, each of which is disposed in relation to a tool base 110, and the charging pad 140 is provided with a wireless charging transmitter 141, so that the wireless charging transmitter 141 of the charging pad 140 is disposed in relation to a wireless charging receiver 131 of the smart tool holder 120 on the tool base 110 after the smart tool holder 120 is incorporated into the tool magazine 100, with a holding distance to wirelessly charge the rechargeable battery 132, and to avoid the charging pad 140 colliding with the smart tool holder 120. The charging pad 140, which is the transmitting end of the present design, is energized by the wireless charging transmitter 141 to generate a magnetic field, which electromagnetically interacts with the wireless charging receiver 131 inside the smart tool holder 120 to achieve the effect of charging the rechargeable battery 132.

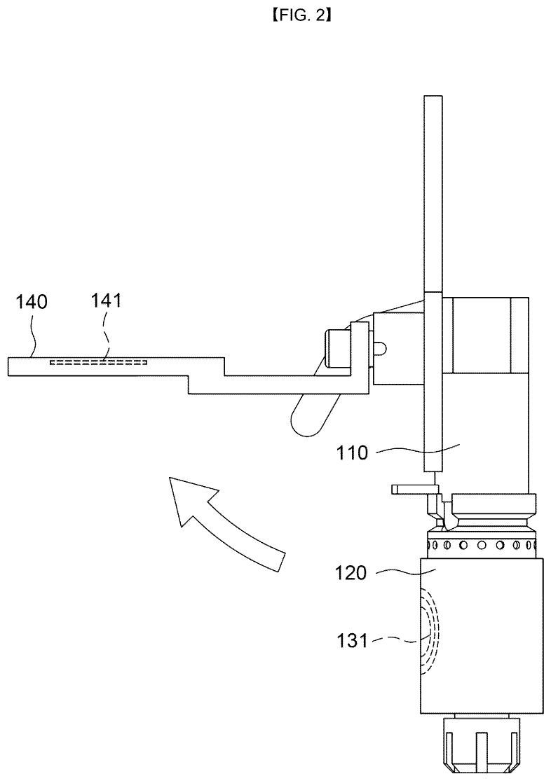

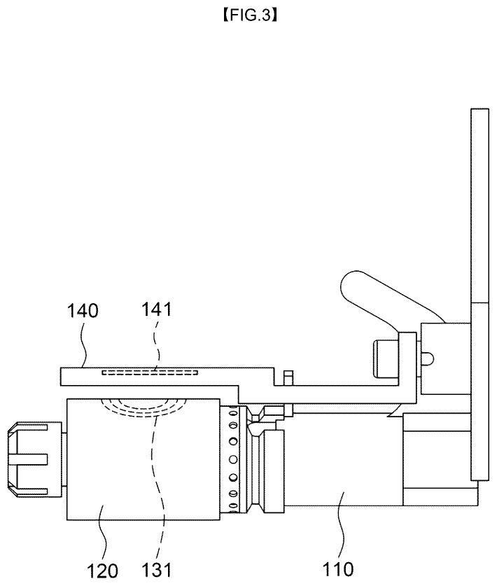

Referring again to FIGS. 2 and 3, when the tool magazine 100 is reversed for tool change (as shown in FIG. 2), the charging pad 140 of the wireless charging end will not be reversed together with the smart tool holder 120, but will be fixed in a position in the tool magazine 100 which is affixed to the smart tool holder 120 when it is being retracted. After the tool magazine 100 is closed (as shown in FIG. 3), wireless charging will be available. The reason for fixing the charging pad 140 of the wireless charging end in the original position during the tool change is to reduce the risk of damage during the tool change, because the charging pad 140 has a distance limitation in the rechargeable condition, and if the charging pad 140 and the tool base 110 are used together to change the tool, there is a high risk of damage due to the charging pad 140 being struck by the tool changer arm during the tool change process, because the tool changer arm will be clamped on both sides of the tool handle and rotated 180 degrees to change the tool. In addition, to be able to charge, it must fit within 1 cm, and the width of the fixture of the tool changer arm is much wider than 1 cm, so that the charging pad 140 does not fall down together with the tool base 110 to change the tool during the reversal of the tool change.

In implementation, the tool magazine 100 will be capable of wireless charging after the tool base is closed (as shown in FIG. 3), and the wireless charging distance between the wireless charging transmitter 141 on the charging pad 140 and the wireless charging receiver 131 of the smart tool holder 120 is greater than the holding distance for wireless charging. This is because most of the current wireless charging technologies wirelessly charge electronic devices in a short range near magnetic field, so the distance between the wireless charging transmitter 141 and the wireless charging receiver 131 needs to be smaller than the wireless charging distance in the implementation.

The smart tool holder 120 further comprises a charge detection module 133 electrically coupled to the wireless charging receiver 131 to control the wireless charging transmitter 141 to wirelessly charge the rechargeable battery 132 when the smart tool holder 120 detects that the smart tool holder 120 has been relatively positioned at the charging pad 140.

In implementation, the wireless charging transmitter 141 and the wireless charging receiver 131 are electromagnetically inductively coupled for power transmission. The most common wireless charging method is to use the induced magnetic flux generated on both sides of the power supply side (the wireless charging transmitter 141) and the power receiving side (the wireless charging receiver 131) for power transmission, and the circuit structure is relatively simple, and the charger can be miniaturized at a low cost.

In implementation, the wireless charging transmitter 141 and the wireless charging receiver 131 are coupled by magnetic field resonance for power transmission. The power transmission is carried out by using the magnetic field resonance generated by the resonators at the two ends of the power supply side (the wireless charging transmitter 141) and the power receiving side (the wireless charging receiver 131).

In implementation, the wireless charging transmitter 141 and the wireless charging receiver 131 are coupled to each other by an electric field for power transmission. The power is transmitted by using a capacitor formed by connecting electrodes to each of the supply side (the wireless charging transmitter 141) and the receiving side (the wireless charging receiver 131) to generate a current flow phenomenon (harmonic current) in the receiving side through high frequency transmission, and the power is transmitted. Although this is the same as the electromagnetic inductive coupling method for short distance transmission, it has the advantage that it is less susceptible to deviation from the placement position and less heat is generated at the power supply area.

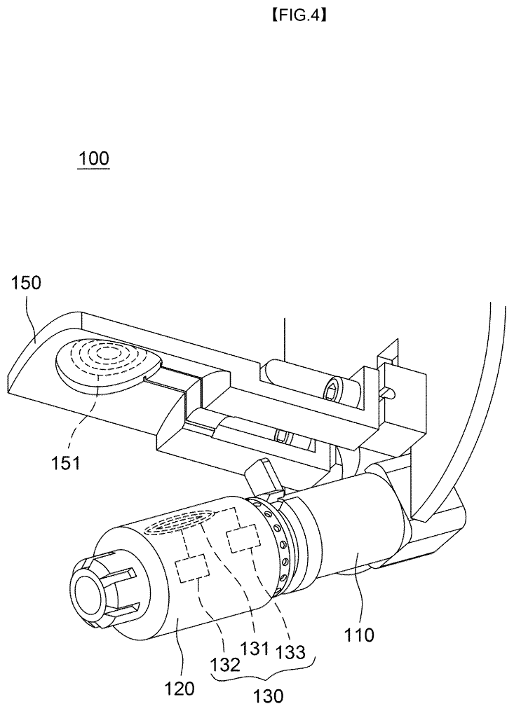

In the implementation application of the charging pad 140, the charging pad 140 and the wireless charging transmitter 141 are in a flat shape (as shown in FIG. 1) facing the wireless charging receiver 131 of the smart tool holder 120. Or, the charging pad 150 and the wireless charging transmitter 151 are in a curved shape (as shown in FIG. 4) and the curved concave surface faces the wireless charging receiver 131 of the smart tool holder 120. In this case, the wireless charging pad can be designed for the different sizes and lengths of each type of smart tool holder 120 and the different types and angles of the tool bases 110, and in order to more closely match the different tool bases 110 and the different smart tool holders 120, the charging pad 140, which is originally in the form of a pad, can be changed into a curved shape to be more closely matched with the body of the smart tool holders 120, so as to achieve a better charging efficiency.

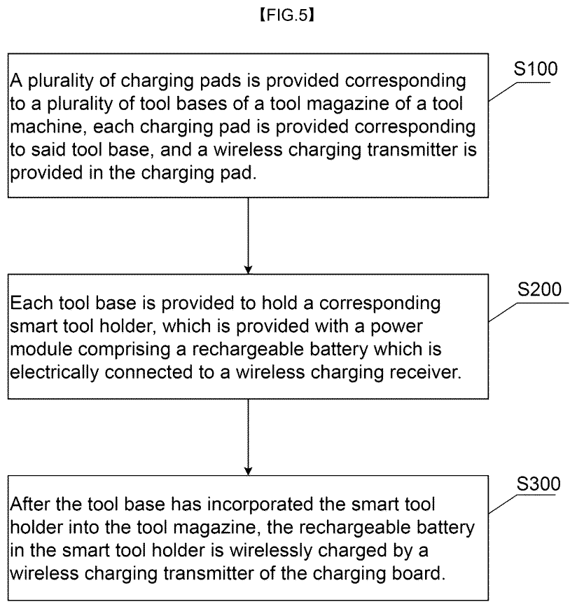

In addition, FIG. 5 contains a wireless charging method for a smart tool holder, comprising:

S100: A plurality of charging pads is provided corresponding to a plurality of tool bases of a tool magazine of a tool machine, each charging pad is provided corresponding to said tool base, and a wireless charging transmitter is provided in the charging pad.

S200: Each tool base is provided to hold a corresponding smart tool holder, which is provided with a power module comprising a rechargeable battery which is electrically connected to a wireless charging receiver.

S300: After the tool base has incorporated the smart tool holder into the tool magazine, the rechargeable battery in the smart tool holder is wirelessly charged by a wireless charging transmitter of the charging board.

The embodiments disclosed above are merely illustrative of the principles, features and effects of the present invention, and are not intended to limit the scope of implementation of the present invention, and any person skilled in the art may make modifications and alterations to the above embodiments without violating the spirit and scope of the present invention. Any equivalent changes and modifications accomplished by applying the disclosure of this invention shall still be covered by the scope of the patent application hereinafter.

1. A wireless charging mechanism for a smart tool holder, applied to a tool magazine of a tool machine, comprising:
a tool base which holds a corresponding smart tool holder, the smart tool holder having a power module providing power to an electronic module within the smart tool holder, the power module comprising a rechargeable battery, and the rechargeable battery being electrically connected to a wireless charging receiver;
a charging pad corresponding to the tool base, with a wireless charging transmitter provided in the charging pad, wherein the wireless charging transmitter of the charging pad corresponds to the wireless charging receiver of the smart tool holder on the tool base at a holding distance to wirelessly charge the rechargeable battery after incorporation of the smart tool holder into the tool magazine;
wherein when the tool magazine receives the tool, the charging pad wirelessly charges the rechargeable battery;
wherein when the tool magazine is reversed for tool change, the charging pad will be fixed in a position in the tool magazine which is affixed to the smart tool holder being retracted, and the charging pad will not wirelessly charges the rechargeable battery.

2. The wireless charging mechanism for the smart tool holder of claim 1, wherein the wireless charging transmitter has a wireless charging distance between the wireless charging receiver and the wireless charging transmitter that is greater than the holding distance.

3. The wireless charging mechanism for the smart tool holder of claim 1, wherein the smart tool holder further comprises a charge detection module electrically coupled to the wireless charging receiver for detecting that the smart tool holder has been positioned relative to the charging pad, and controlling the wireless charging transmitter to wirelessly charge the rechargeable battery.

4. The wireless charging mechanism for the smart tool holder of claim 1, wherein the wireless charging transmitter and the wireless charging receiver are electromagnetically inductively coupled for power transmission.

5. The wireless charging mechanism for the smart tool holder of claim 1, wherein the wireless charging transmitter and the wireless charging receiver are coupled by magnetic field resonance for power transmission.

6. The wireless charging mechanism for the smart tool holder of claim 1, wherein the wireless charging transmitter and the wireless charging receiver are coupled by electric field for power transmission.

7. The wireless charging mechanism for the smart tool holder of claim 1, wherein the charging pad and the wireless charging transmitter are in a planar position facing the wireless charging receiver of the smart tool holder.

8. The wireless charging mechanism for the smart tool holder of claim 1, wherein the charging pad and the wireless charging transmitter are in a curved shape, and the curved concave surface corresponds to the wireless charging receiver of the smart tool holder.

9. A wireless charging method for a smart tool holder, the method comprising:
providing a charging pad corresponding to a tool base of a tool magazine of a tool machine, wherein the charging pad having a wireless charging transmitter provided therein;
wherein the tool base holds a corresponding smart tool holder having a power module comprising a rechargeable battery electrically connected to a wireless charging receiver;
wherein the rechargeable battery in the smart tool holder is wirelessly charged by a wireless charging transmitter of the charging pad after the smart tool holder has incorporated the smart tool holder into the tool base's magazine;
wherein when the tool magazine receives the tool, the charging pad wirelessly charges the rechargeable battery;
wherein when the tool magazine is reversed for tool change, the charging pad is fixed in a position in the tool magazine which is affixed to the smart tool holder being retracted, and the charging pad does not wirelessly charge the rechargeable battery.

10. The method for wirelessly charging a smart tool holder of claim 9, wherein the smart tool holder comprises a charge detection module electrically coupled to the wireless charging receiver for controlling the wireless charging transmitter to wirelessly charge the rechargeable battery when it detects that the smart tool holder has been positioned relative to the charging pad.
